(19) United States
(12) Patent Application Publication
(10) Pub. No.: US 2002/0102956 A1
(43) Pub. Date: Aug. 1, 2002

(54) Wireless communication method and system for automatically setting frequency channel and tone squelch

(76) Inventors: Kon-Hee Lee, Seoul (KR); In-Hee Lee, Yongin-shi (KR)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/771,987

(22) Filed: Jan. 30, 2001

(51) Int. Cl. H04B 1/18; H04B 1/10

(52) U.S. Cl. 455/219; 455/218; 455/212; 455/150.1; 455/179.1

(57) ABSTRACT

A wireless communication system comprises a filter and amplifier for filtering/amplifying only a necessary band frequency from a receive information signal induced by an antenna and passing a duplexer portion; a mixer for mixing the band frequency with a phase synchronizing signal from a local oscillating portion; a demodulating portion for demodulating a signal from the mixer and supplying the demodulated signal to a speaker; a receive tone squelch circuit for separating a sound signal from the demodulated signal; a transmit modulating portion for combining a transmit signal input with a transmit tone squelch frequency from a transmit tone squelch circuit and demodulating the combined signal; a controller for converting a code previously inputted into a code inputting portion into a frequency and tone squelch code; a memory for storing data, which is coded corresponding to a frequency channel data and a tone squelch code selected by the controller, at a predetermined address region; and a display for representing a frequency, etc. set by the controller, thereby selecting a frequency channel and a tone squelch frequency, automatically, according to a code inputted.

### BACKGROUND OF THE INVENTION

The invention is related to providing a wireless communication method and system for automatically setting a frequency channel and a tone squelch by a numeric code input, and particularly, to providing a wireless communication method and system for programming a combination of a channel frequency and a tone squelch using an automatic channel frequency selecting code and a continuous tone controlled squelch system (CTCSS) and setting a frequency channel and a tone frequency, automatically, according to a predetermined code inputted during the transmit-receive operating.

### PRIOR ART

A conventional wireless communication system using FRS performs the communication with another communication system in a manner that a transmit communication system sets a communication frequency channel of a receive communication system and then transmit a predetermined information and converts into a receive mode, and the receive communication system converts the receive mode into the transmit mode so as to transmit information responsive to the transmit information from the transmit communication system.

The conventional wireless communication system has problems as follows: when such like an alternative communication or a simultaneous communication occurs, the communication method needs the confirmation of the communication condition before the communication operating and input them, exactly, by a hand, if the transmit communication system uses a communication frequency and a continuous tone controlled squelch (CTCS) or DCD of the receive communication system. Also, if the receive communication system uses different communication frequency and tone squelch, the transmit communication system must identify the tone squelch code and frequency of the receive communication system upon every the changing of the frequency and tone squelch and requires the changed input.

Accordingly, an object of the invention is to provide a wireless communication method and system for programming a combination of a channel frequency and a tone squelch using an automatic channel frequency selecting code and a continuous tone controlled squelch system code and setting a frequency channel and a tone squelch frequency, automatically, according to a predetermined code inputted during the transmit-receive operating.

The other object of the invention is to provide a wireless communication method and system for combining a channel frequency and a tone squelch in a numeric code and setting a frequency channel and a tone frequency, automatically, according to a specific numeric code input that is easily learned by heart and enables the convenient use during the transmit-receive operating.

### SUMMARY OF THE INVENTION

In order to resolve these objects, according to the invention a wireless communication system for automatically setting a frequency channel and a tone squelch comprises a filter and amplifier for filtering/amplifying only a necessary band frequency from a receive information signal induced by an antenna and passing a duplexer portion; a mixer for mixing the band frequency with a phase synchronizing signal from a local oscillating portion; a demodulating portion for demodulating a signal from the mixer and supplying the demodulated signal to a speaker; a receive tone squelch circuit for separating a sound signal from the demodulated signal; a transmit modulating portion for combining a transmit signal input with a transmit tone squelch frequency from a transmit tone squelch circuit and demodulating the combined signal; a controller for converting a code previously inputted into a code inputting portion into a frequency and tone squelch code; a memory for storing data, which is coded corresponding to a frequency channel data and a tone squelch code selected by the controller, at a predetermined address region; and a display for representing a frequency, etc. set by the controller.

A wireless communication method for selecting a communication frequency comprises steps of: storing a frequency channel code and a modulating frequency converting code at a memory, previously; inputting data at a waiting mode of a system corresponding to the frequency channel code and the modulating frequency converting code; converting into a transmit mode after the completion of the data input step; setting a frequency channel according to the frequency channel code after the completion of the transmit mode convert step; and transmitting information according to the modulating frequency convert code after the completion of the frequency channel setting.

### BRIEF DESCRIPTION OF THE DRAWINGS

The invention now will be described in detail with reference to the accompanying drawings, in which:

FIG. 1 is a block diagram illustrating a wireless communication system according to the invention;

FIG. 2 is a view illustrating a code for the frequency channel selection and a tone squelch code of the wireless communication system according to the invention;

FIG. 3 is a view of tables illustrating frequencies of channel codes divided into countries used in the wireless communication system according to the invention;

FIG. 4 is a table illustrating frequencies of a tone code of a continuous tone controlled squelch system of the wireless communication system (CTCSS) according to the invention;

FIG. 5 is a table illustrating tone codes of DCD system of the wireless communication system according to the invention; and,

FIG. 6 is a flow chart illustrating the operating of the wireless communication system according to the invention.

### DETAILED DESCRIPTION OF THE INVENTION

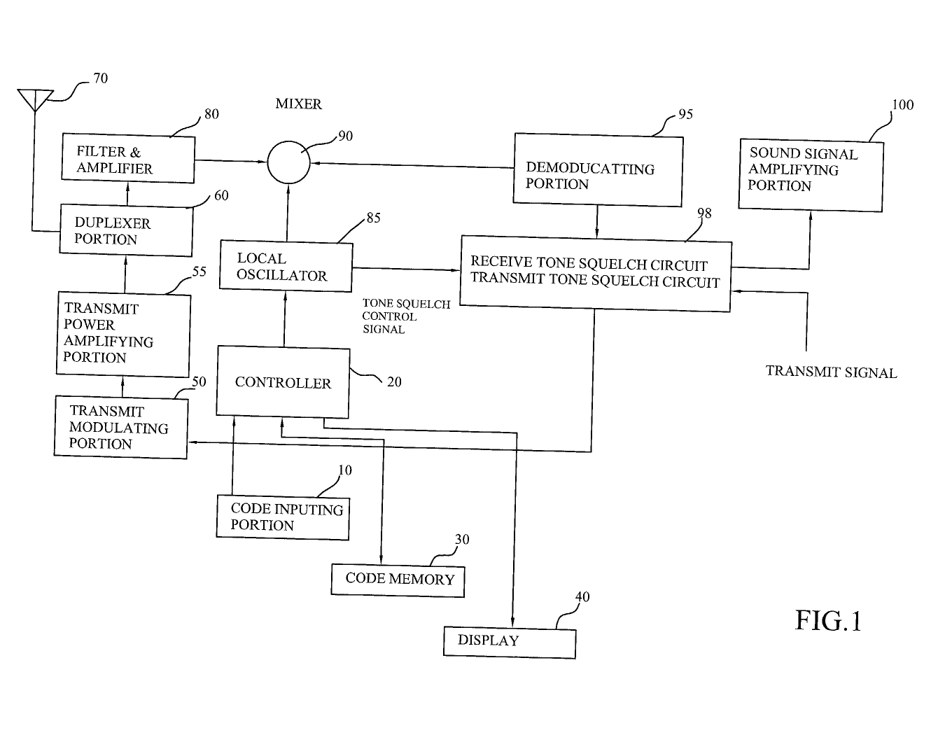

FIG. 1 shows a block diagram of a wireless communication system. A filter and amplifier 80 includes an amplifier and a band pass filter for amplifying a receive information signal induced by an antenna 70 and passing through a duplexer portion 60 and filtering only a necessary band frequency from the receive information signal. A mixer 90 mixes the receive signal from the filter and amplifier 80 with a phase synchronizing signal from a local oscillator 85 to apply the mixed signal to a demodulating portion 95. The local oscillator 85 applies a tone squelch control signal to a tone squelch portion 98.

The tone squelch portion 98 removes a tone squelch frequency signal from the demodulated signal from the demodulating portion 95 to generate a sound signal. In other words, the tone squelch portion 98 includes a receive tone squelch circuit and a transmit tone squelch circuit connected to a microphone or a transmit circuit, etc. (not shown), in which the transmit tone squelch circuit combines a transmit signal from the transmit circuit with a tone squelch signal to supply the combined signal to a transmit modulating portion 50, and the receive tone squelch circuit applies the sound signal to a sound signal amplifying portion 100 to output the sound.

The transmit modulating portion 50 modulates the combined signal and applies the modulated signal to a transmit power amplifying portion 55. The transmit power amplifying portion 55 amplifies the modulated signal and forces the amplified signal through the duplexer portion 60 and the antenna 70 to be transmitted to another wireless communication system.

A controller 20 includes a code inputting portion 10, a display 40 for representing the code inputted and a memory 30 for storing data corresponding to a transmit-receive frequency and a tone squelch frequency at a predetermined address region, when a code data inputted into the code inputting portion 10 is converted.

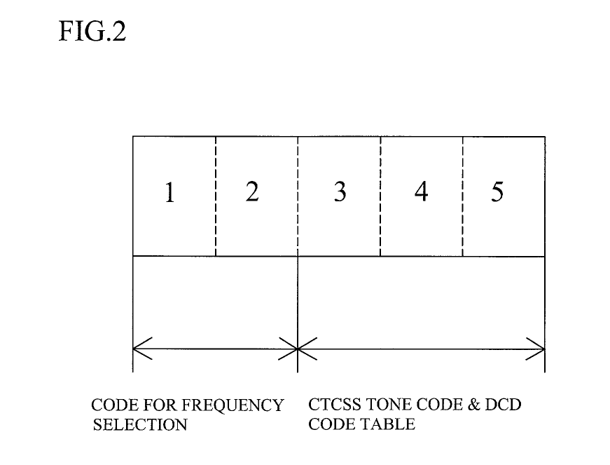

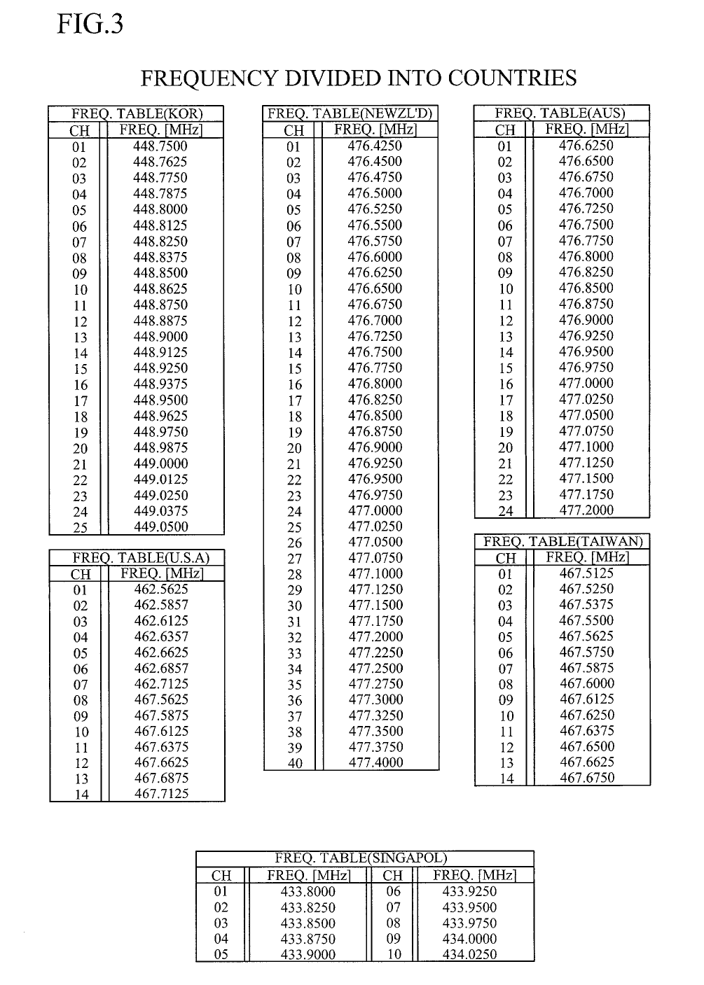

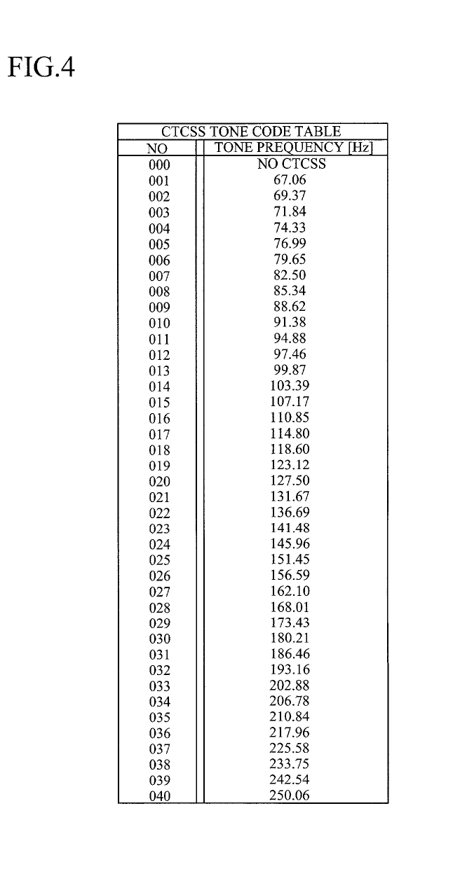

The wireless communication system is operated as follows: FIG. 2 shows a code for the frequency channel selection and a tone squelch code of the wireless communication system. As shown in FIGS. 3 and 4, the memory 30 memorizes different channel frequencies and tone squelch codes or frequencies at every specific address. The channel frequency is allotted to each of country as shown in FIG. 3. For example, the South Korea has 25 channel frequencies, America has 14 channel frequency, New Zealand has 40 channel frequencies, Australia has 24 channel frequencies, Taiwan has 14 channel frequencies and Singapore has 10 channel frequencies. Therefore, each country allots any one of 00 to 99 as a peculiar number of two digits corresponding to a channel frequency to every channel frequency. The table of FIG. 3 is stored at a memory of a wireless communication system in the form of a lookup table.

As shown in FIG. 4, the tone squelch of the continuous tone controlled squelch system has total 40 squelch frequencies to which any one of 000 to 999 as a peculiar number of three digits corresponding to each tone frequency is allotted. “000” represents a non-modulation of the CTCSS.

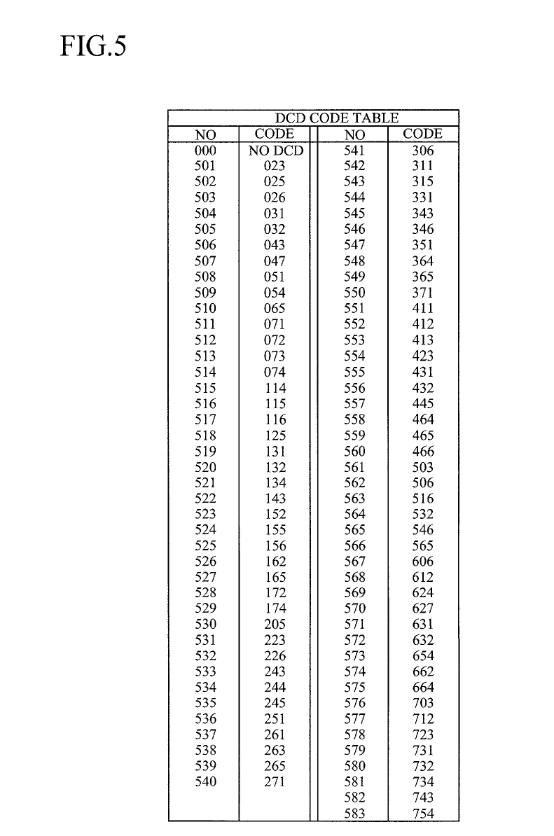

As shown in FIG. 5, a digital tone squelch includes total 83 tone codes, to which any one of 000 to 999 as a peculiar number of three digits corresponding to each tone frequency is allotted.

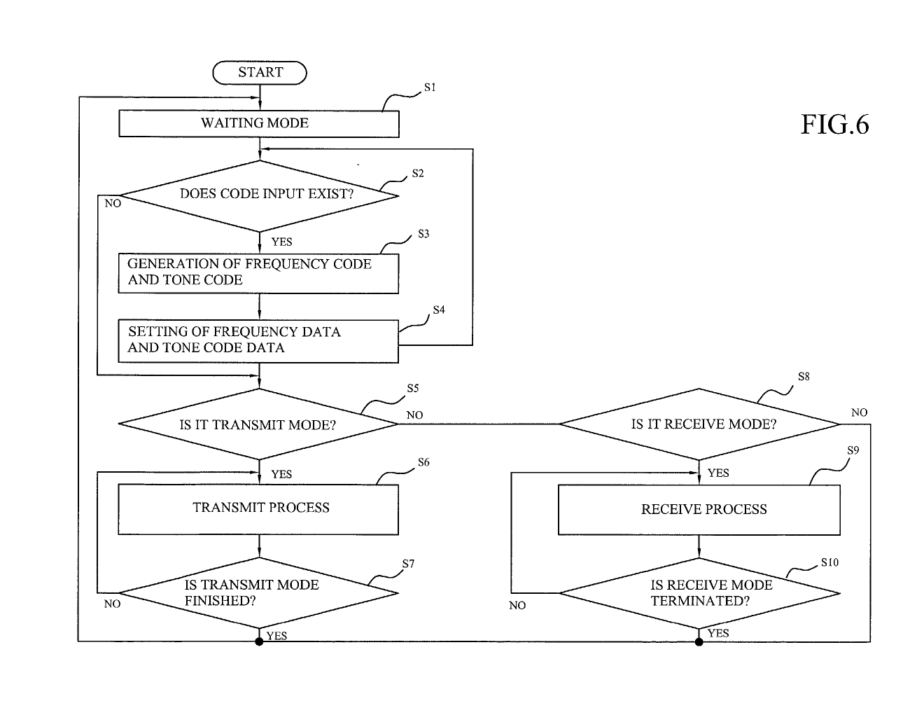

FIG. 6 shows a flow chart of a wireless communication method according to the invention. The wireless communication method comprises steps as follows: step S1 shows that the communication system is in a waiting mode. The memory 30 stores required channel frequencies and tone frequencies previously inputted at the specific address region. At step S2, it is judged whether the inputting portion 10 receives continuous inputs of a numeric key to make five digits corresponding to a frequency channel code and a tone frequency necessary for transmitting a specific information as shown in FIG. 2.

Next, if the transmit mode is selected or a user presses a TALK key, step S2 goes to step S3 that the controller 20 reads first two digits of the five digits inputted referring to the tone frequency table stored at the memory 30 and generates a frequency code and a tone code. Step S3 proceeds to step S4 that the controller 20 sets a transmit frequency at a corresponding tone frequency.

At step S6, it is judged whether a transmit input exists. If so, step S6 goes to step S7 that the controller 20 performs the transmit process in a manner to get two digit code of five digits inputted into the inputting portion 10 to select the frequency channel and three digit code to select the modulation frequency. The modulating portion 50 applies the transmit signal through the duplexer portion 60 and the antenna 79 to another wireless communication system.

At step S7, it is judged whether the transmit is finished. If so, step S7 jumps to step S1 that the wireless communication system converts into the receive waiting mode.

If the wireless communication system is not in the transmit mode, step 5 goes to step S8 that it is judged whether the receive signal exists. If so, step 8 goes to step S9 that the controller 20 performs the receive process. Step S9 proceeds to step S10 that it is judged whether the receive process is terminated. If so, step 10 jumps to step S1 that the wireless communication system converts into the receive waiting mode.

As described above, the invention enable only the numeric keys of the five digits to be inputted without performing inputs according to the setting of a channel frequency and a tone squelch, so that a corresponding channel frequency and tone squelch is automatically set, thereby enhancing the use convenience:

WHAT IS CLAIMED IS:

1. A wireless communication system wireless communication method and system for automatically setting a frequency channel and a tone squelch comprising:
a filter and amplifier for filtering/amplifying only a necessary band frequency from a receive information signal induced by an antenna and passing a duplexer portion;
a mixer for mixing the band frequency with a phase synchronizing signal from a local oscillating portion;
a demodulating portion for demodulating a signal from the mixer and supplying the demodulated signal to a speaker; a receive tone squelch circuit for separating a sound signal from the demodulated signal;
a transmit modulating portion for combining a transmit signal input with a transmit tone squelch frequency from a transmit tone squelch circuit and demodulating the combined signal;
a controller for converting a code previously inputted into a code inputting portion into a frequency and tone squelch code;
a memory for storing data, which is coded corresponding to a frequency channel data and a tone squelch code selected by the controller, at a predetermined address region; and,
a display for representing a frequency, etc. set by the controller.

2. A wireless communication method for automatically setting a frequency channel and a tone squelch comprising steps of:
storing a frequency channel code and a modulating frequency converting code at a memory, previously;
inputting data at a waiting mode of a system corresponding to the frequency channel code and the modulating frequency converting code;
converting into a transmit mode after the completion of the data input step;
setting a frequency channel according to the frequency channel code after the completion of the transmit mode convert step; and,
transmitting information according to the modulating frequency convert code after the completion of the frequency channel setting.
